(19) United States
(12) Patent Application Publication
(10) Pub. No.: US 2010/0031827 A1
(43) Pub. Date: Feb. 11, 2010

(54) TEA MAKER

(76) Inventor: Ying-Hsu Lai, Taipei County (TW)

Correspondence Address: Ying-Hsu Lai, 235 Chung - Ho, Box 8-24, Taipei, TW

(21) Appl. No.: 12/186,522

(22) Filed: Aug. 6, 2008

(51) Int. Cl. A47J 31/02; A47J 31/18

(52) U.S. Cl. 99/306; 99/317

(57) ABSTRACT

A portable tea maker includes an upper pot body, a ring, and a lower pot body. The upper pot body has a pyramid installed inside thereof. A filter is installed inside the pyramid and a through hole is formed to the pyramid. The ring is hollow and an isolated sheet is arranged in the middle thereof. The lower pot body has an outlet portion on an end thereof. A receiving space is formed to another end of the lower pot body so as to receive the ring. By twisting the upper pot body from the lower pot body, the tea will be separated from the tea leaves. The tea is available for drinking by turning the up side down of the upper pot body and the lower pot body.

### FIELD OF THE PRESENT INVENTION

The present invention relates to tea maker, and in particular to a portable tea maker which is capable of being twisting to perform a better tea making process and to a portable tea maker which is easy to drink by turning the upper and lower pot body.

### DESCRIPTION OF THE PRIOR ART

A prior tea maker is designed as a cup with a filter cup inside thereof. When making tea, hot water is full filled with the cup and the tea leaves are supplied to the filter cup. When drinking tea, to avoid the tea leaves, the filter cup has to be removed. By doing that, the tea will drop out from the filter and the filter cup is hard to be placed. Moreover, the filter cup is fixed inside the cup so that the tea will become bitterer and bitterer with time that the tea leaves are soaked in the tea. Therefore, to solve the inconvenience of the prior art, the inventor of the present invention spent years to research and successfully completed the invention with great improvement.

### SUMMARY OF THE PRESENT INVENTION

Accordingly, the present invention provides a portable tea maker which includes an upper pot body, a ring, and a lower pot body. The upper pot body has an upper cover and a pyramid installed inside thereof. A filter is installed inside the pyramid and a through hole is formed to the pyramid. The ring is hollow and an isolated sheet is arranged in the middle thereof. The lower pot body has a lower cover and an isolated ring is arranged to the lower cover. The lower pot body further has an outlet portion on an end thereof. A receiving space is formed to another end of the lower pot body so as to receive the ring. By twisting the upper pot body from the lower pot body, the tea will be separated from the tea leaves and flows into the lower pot body. The tea is available for drinking by turning the up side down of the upper pot body and the lower pot body.

### BRIEF DESCRIPTION OF THE DRAWINGS

FIG. 1 is an exploded view of the present invention.

FIG. 2 is a cross section view of an upper pot body of the present invention.

FIG. 3 is a cross section view of a lower pot body of the present invention.

FIG. 4 is an assembly view of the present invention.

FIG. 5 is a cross section view of the present invention.

FIG. 6 is a schematic view showing the tea making operation of the present invention.

FIG. 7 is a schematic view showing the separation of the tea and the tea leaves of the present invention.

FIG. 8 is a schematic view showing the turning of the present invention.

FIG. 9 is a schematic view showing the drinking of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

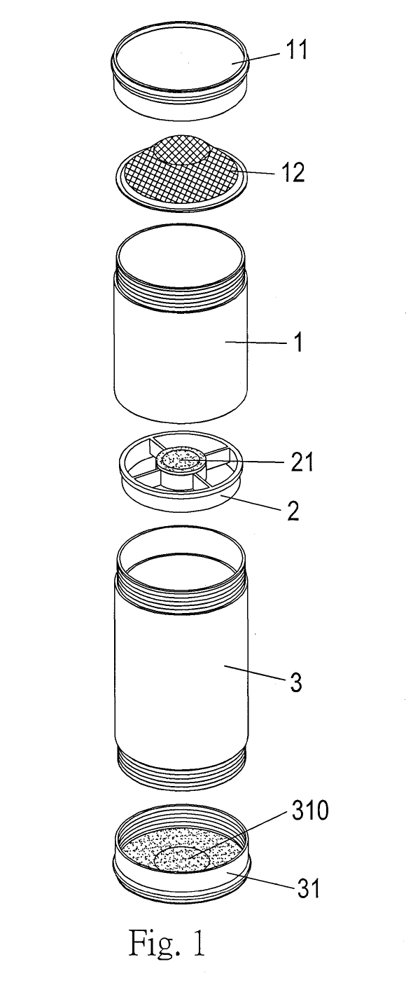

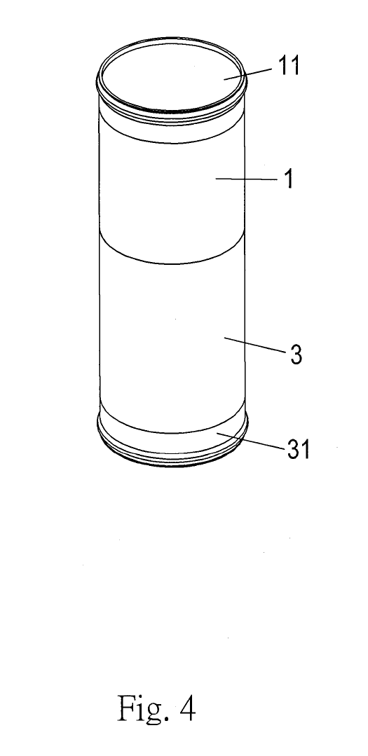

Referring to FIGS. 1, 4 and 5, a portable tea maker of the present invention includes an upper pot body 1, a ring 2, and a lower pot body 3. The upper pot body 1 has an upper cover 11 and a filter which is installed into the upper pot body 11. The ring 2 is hollow and an isolated sheet 21 is arranged in the middle thereof. The lower pot body 31 has a lower cover 31 and an isolated ring 310 is arranged to the lower cover 31. The tea will flow into the lower pot body 3 from the upper pot body 1 by twisting the upper pot body 1 from the lower pot body 3 so as to separate the tea and the tea leaves. To drink the tea from the lower pot body 3, turning the up side down of the upper pot body 1 and the lower pot body 3 can be done.

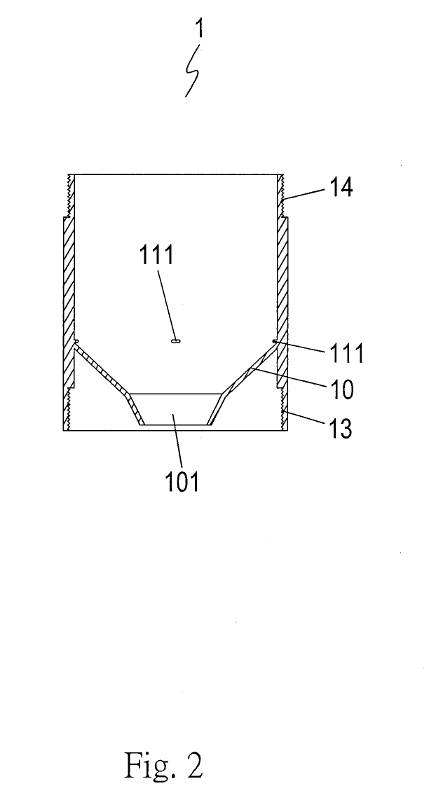

Referring to FIGS. 1 and 2, the portable tea maker of the present invention has a pyramid 10 which is installed in the upper pot body 1. The filter 12 is installed inside the pyramid 10. A through hole 101 is formed to the pyramid 10 and a protrusion 111 is formed inside the upper pot body 1 so as to prevent the filter from escaping.

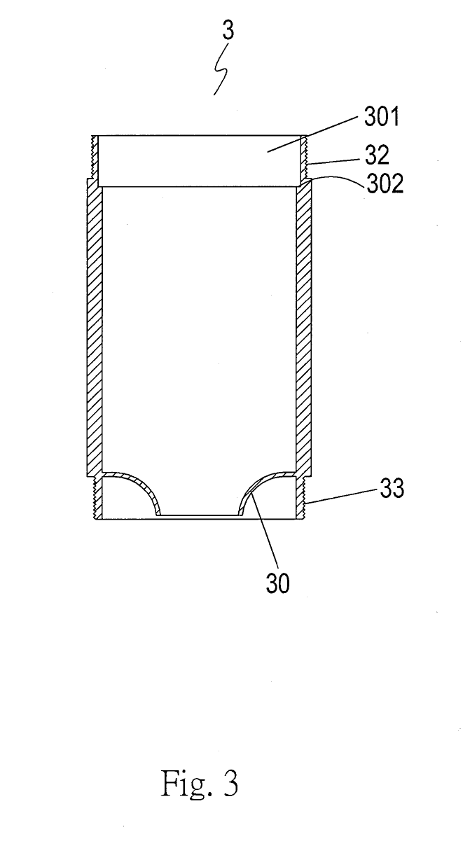

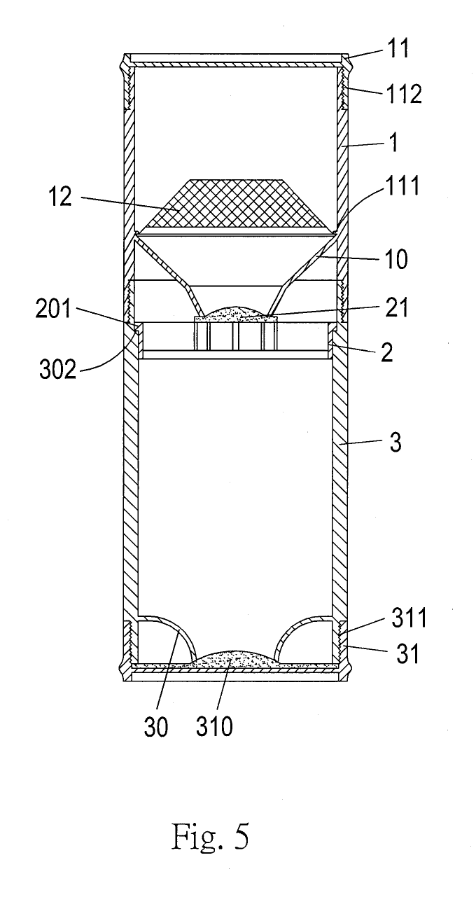

With reference to FIGS. 3 and 5, the portable tea maker has an outlet portion 30 on an end of the lower pot body 3. A receiving space 301 is formed to another end of the lower pot body 3 so as to receive the ring 2. The ring 2 has an edge portion 201 which is capable of buckling a flange 302 inside the receiving space 301.

With reference to FIGS. 2, 3, and 5, the portable tea maker of the present invention is illustrated. An inner thread 13 of the upper pot body 1 is screwed to an outer thread 32 of the lower pot body 3. An inner thread 112 of the upper cover 11 is screwed to an outer thread 14 of the upper pot body 1. An inner thread 311 of the lower cup 31 is screwed to an outer thread 33 of the lower pot body 3.

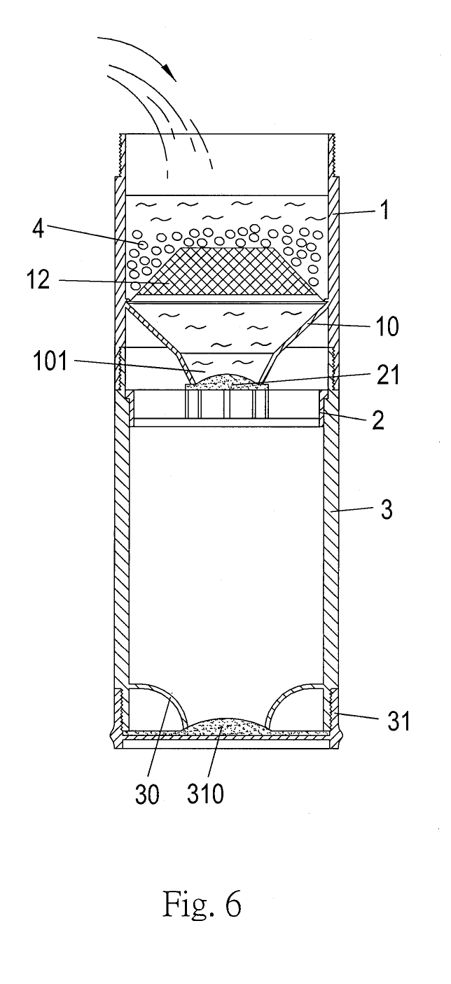

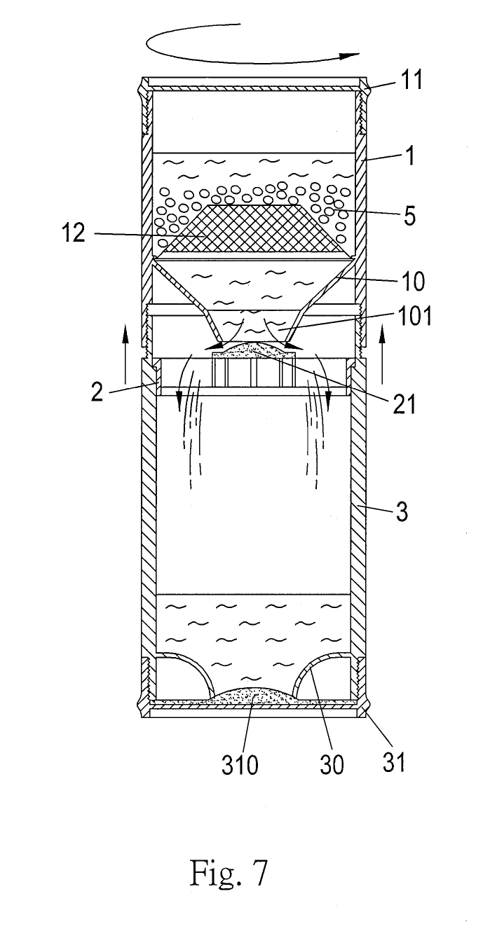

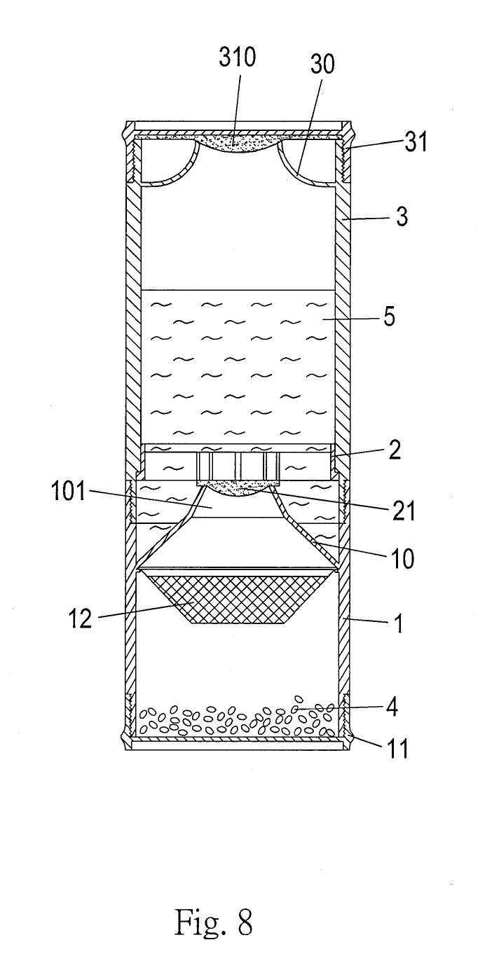

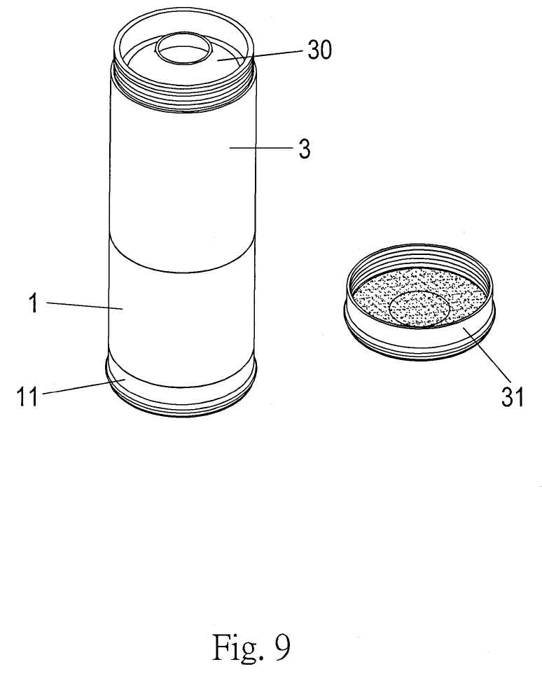

With reference to FIGS. 6, 7, 8, and 9, an embodiment of the present invention is illustrated. While using the portable tea maker, the upper pot body 1 is tightly screwed to the lower pot body 3. Through the isolated sheet 21 of the ring 2, the through hole 101 on the pyramid 10 of the upper pot body 1 is sealed. Tea leaves and hot water can be filled into the upper pot body 1 by opening the upper cover 11 (see FIG. 6). After screwing the upper cover 11 with tea leaves and hot water inside the upper pot body 1 with a predetermined interval and by twisting the upper pot body 1 from the lower pot body 3, the isolated sheet 21 of the ring 2 will escape from the through hole 101 of the pyramid 10 so that the tea 5 will flow into the lower pot body 3 (see FIG. 7). After the tea 5 is separated to the tea leaves 4, the isolated sheet 21 of the ring 2 will seal the through hole 101 of the pyramid 10 by screwing the upper pot body 1 to the lower pot body 3. The lower pot body 3 can be used as a cup (see FIG. 8) by turning the up side down of the upper pot body 1 and the lower pot body 3. The tea is available for drinking by opening the lower cover 31 (see FIG. 9). The present invention can prevent the tea leaves 4 being soaked too long and is very practical with mobility.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A portable tea maker comprising:
an upper pot body with a upper cover on an end thereof; a pyramid with a through hole being arranged in the upper pot body for receiving a filter;
a lower pot body with a lower cover on an end thereof; the lower cover being formed with an isolated ring; an end of the lower pot body being formed with an outlet portion; another end of the lower pot body being formed with a receiving space for receiving a ring; and
a hollow ring with an isolated sheet in the middle thereof.

2. The portable tea maker as claimed in claim 1, wherein the upper pot body has an inner thread for 1 being screwed to an outer thread of the lower pot body.

3. The portable tea maker as claimed in claim 1, wherein the upper cover has an inner thread for of being screwed to an outer thread of the upper pot body.

4. The portable tea maker as claimed in claim 1, wherein the lower cover has inner thread for being screwed to an outer thread of the lower pot body.

5. The portable tea maker as claimed in claim 1, wherein the upper pot body has a protrusion for preventing the filter from escaping.
